(19) United States
(12) Patent Application Publication
(10) Pub. No.: US 2026/0227665 A1
(43) Pub. Date: Aug. 6, 2026

(54) LIQUID CRYSTAL DISPLAY DEVICE

(71) Applicant: Sharp Display Technology Corporation, Kameyama City (JP)

(72) Inventors: Kuniaki OKADA, Kameyama City (JP); Atsushi HACHIYA, Kameyama City (JP)

(21) Appl. No.: 19/450,022

(22) Filed: Jan. 15, 2026

(30) Foreign Application Priority Data
Jan. 31, 2025 (JP) 2025-015557

(51) Int. Cl. G02F 1/1362; G02B 27/01

(52) U.S. Cl. CPC G02F 1/136286; G02F 1/136222; G02B 27/0172

(57) ABSTRACT

A liquid crystal display device includes an active matrix substrate, a counter substrate, and a liquid crystal layer. The active matrix substrate includes a substrate, a plurality of source bus lines, a plurality of gate bus lines, and a plurality of pixels. Each of the plurality of pixels includes a semiconductor layer located between the substrate and the one gate bus line, a first insulator located at least between the semiconductor layer and the one gate bus line, a second insulator located at least on the one gate bus line, a first contact hole extending at least through the second insulator, a first pixel electrode connected to the semiconductor layer, a color filter layer, a second contact hole extending through the color filter layer, and a second pixel electrode connected to the first pixel electrode.

### CROSS-REFERENCE TO RELATED APPLICATIONS

This application claims the benefit of priority to Japanese Patent Application Number 2025-015557 filed on Jan. 31, 2025. The entire contents of the above-identified application are hereby incorporated by reference.

### BACKGROUND

### Technical Field

The disclosure relates to a liquid crystal display device.

For a high-resolution liquid crystal display device, a color filter on array (COA) structure in which a color filter is disposed on a TFT substrate may be adopted to suppress a decrease in display quality due to a positional offset between a counter substrate and the TFT substrate. JP 2017-68016 A discloses a liquid crystal display device that has such a structure and can improve display quality.

### SUMMARY

An object of the disclosure is to provide a liquid crystal display device that has a COA structure and that can provide high-resolution display and be manufactured with high yield.

A liquid crystal display device according to an embodiment of the disclosure includes an active matrix substrate, a counter substrate disposed opposite the active matrix substrate, and a liquid crystal layer located between the active matrix substrate and the counter substrate. The active matrix substrate includes a substrate including a display region, a plurality of source bus lines extending in a first direction in the display region, a plurality of gate bus lines extending in a second direction intersecting the first direction in the display region, and a plurality of pixels located on the display region of the substrate, and each of the plurality of pixels is connected to one of the plurality of source bus lines and one of the plurality of gate bus lines. Each of the plurality of pixels includes a semiconductor layer located between the substrate and the one gate bus line and partially overlapping with the one gate bus line in a plan view, a first insulator located at least between the semiconductor layer and the one gate bus line, a second insulator located at least on the one gate bus line, a first contact hole extending at least through the second insulator to expose a portion of the semiconductor layer, a first pixel electrode located at least on a portion of the second insulator and in a portion of the first contact hole, connected to the semiconductor layer, and partially overlapping with the one gate bus line in a plan view, a color filter layer disposed in the pixel to cover the first pixel electrode, a second contact hole extending through the color filter layer to expose the first pixel electrode at a position above the one gate bus line, and a second pixel electrode located above the color filter layer and at least in a portion of the second contact hole, and connected to the first pixel electrode. The second contact hole has a groove shape extending in parallel to the second direction and being continuous with the second contact hole of a neighboring pixel. The second contact hole includes a first sidewall portion and a second sidewall portion each extending in parallel to the second direction, and further includes a bottom portion located between the first sidewall portion and the second sidewall portion, a first boundary between the bottom portion and the first sidewall portion, and a second boundary between the bottom portion and the second sidewall portion. The first boundary is closer to the first contact hole than the second boundary, and at least one of the first boundary or the second boundary is located above the one gate bus line in a plan view.

According to an embodiment of the disclosure, a liquid crystal display device that has a COA structure and that can provide high-resolution display and be manufactured with high yield is provided.

### BRIEF DESCRIPTION OF DRAWINGS

The disclosure will be described with reference to the accompanying drawings, wherein like numbers reference like elements.

FIG. 1 is a schematic cross-sectional view illustrating a configuration example of a liquid crystal display device according to the present embodiment.

FIG. 2 is a schematic view illustrating an example of a planar structure of an active matrix substrate according to a first embodiment.

FIG. 3 is a schematic view illustrating a circuit configuration of a pixel of the active matrix substrate according to the first embodiment.

FIG. 4 is a schematic plan view illustrating main constituent elements of the pixel of the active matrix substrate according to the first embodiment.

FIG. 5 is a schematic cross-sectional view taken along a line A-A in FIG. 4 and illustrates a structure of the active matrix substrate.

FIG. 6A and FIG. 6B are process cross-sectional views for describing a process of forming a contact hole according to the first embodiment.

FIG. 7 is a schematic cross-sectional view illustrating a structure of an active matrix substrate according to a reference example.

FIG. 8 is an enlarged schematic view illustrating a planar structure of a pixel of an active matrix substrate according to a second embodiment.

FIG. 9 is a schematic cross-sectional view taken along a line A-A in FIG. 8 and illustrates a structure of the active matrix substrate.

FIG. 10 is a schematic cross-sectional view illustrating a structure of an active matrix substrate according to a third embodiment.

FIG. 11A and FIG. 11B are process cross-sectional views for describing a process of forming a contact hole according to the third embodiment.

FIG. 12 is a process cross-sectional view for describing a process of forming a contact hole according to a reference example.

FIG. 13A to FIG. 13C are schematic cross-sectional views illustrating other examples of the shape of a first sidewall portion of a second contact hole.

FIG. 14 is a schematic cross-sectional view illustrating a structure of an active matrix substrate according to another embodiment of the third embodiment.

FIG. 15A to FIG. 15C are schematic cross-sectional views illustrating examples of the shape of the first sidewall portion of the second contact hole according to reference examples.

FIG. 16 is a process cross-sectional view for describing a process of forming a contact hole according to a reference example.

### DESCRIPTION OF EMBODIMENTS

One of the applications of a liquid crystal display device having the COA structure is a head-mounted display. Since the head-mounted display is generally disposed immediately in front of the eyes, in the same manner as with glasses, the distance between the liquid crystal display device and the eyes is short, and the liquid crystal display device is required to have a very high resolution (1000 ppi or higher, for example).

Since the head-mounted display is worn on the head, it is preferable that the head-mounted display be driven by an internal power source. For this reason, it is preferable to use, as a thin film transistor (TFT) for driving a pixel, a TFT including an oxide semiconductor layer excellent in low leakage performance. For example, when realizing a liquid crystal display device having an ultra high resolution of 1000 ppi or higher, as the size of each pixel becomes small, it is preferable to increase the aperture ratio to increase the luminance of white display. For example, it is conceivable to dispose a color filter layer between a pixel electrode and the oxide semiconductor layer and connect the pixel electrode and the oxide semiconductor layer via a contact hole, by utilizing the transparency of the oxide semiconductor layer. In this case, to achieve a sufficient aperture ratio, it is preferable that the contact hole is disposed on a gate bus line.

The present inventors have studied in detail a liquid crystal display device having such a COA structure, and have found that, in a pixel having a smaller size, disconnection of the pixel electrode may occur due to positional offset of a mask during forming the contact holes. The disconnection of the pixel electrode causes a defect of the pixel, and thus the manufacturing yield of the liquid crystal display device is reduced.

To solve the problems described above, the present inventors have conceived a liquid crystal display device having a novel structure. Embodiments of the disclosure will be described below with reference to the drawings. The disclosure is not limited to the following embodiments, and appropriate design changes can be made within a scope that satisfies the configuration of the disclosure. Further, in the description below, the same reference signs may be used in common among the different drawings for the same portions or portions having the same or similar functions, and descriptions of repetitions thereof may be omitted. Further, the configurations described in the embodiments and modified examples may be combined or modified as appropriate within a range that does not depart from the gist of the disclosure. For ease of explanation, in the drawings referenced below, the configurations may be simplified or schematically illustrated, or some components may be omitted. Further, dimensional ratios between components illustrated in the drawings are not necessarily indicative of actual dimensional ratios. Terms “orthogonal” and “parallel” are not limited to a case where sides or surfaces are arranged so as to have a relationship of exactly 90° or 180° with respect to each other, but include a case where two sides, two surfaces, or a side and a surface are arranged within a range of allowable error (about ±3°, for example), that is, for example, within ranges of 87° to 93° and 177° to 183°, respectively.

### First Embodiment

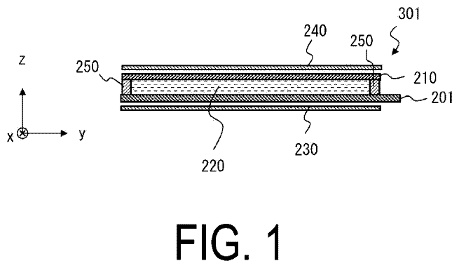

FIG. 1 is a schematic cross-sectional view illustrating a configuration example of a liquid crystal display device 301 according to the present embodiment. The liquid crystal display device 301 includes an active matrix substrate 201, a counter substrate 210, a liquid crystal layer 220, a polarizer 230, and a polarizer 240.

The counter substrate 210 is disposed with a predetermined gap from the main surface of the active matrix substrate 201 by a spacer 250, and the liquid crystal layer 220 is sandwiched between the active matrix substrate 201 and the counter substrate 210. As described below, a color filter layer is not disposed on the counter substrate 210 and is disposed on the active matrix substrate 201.

The polarizer 230 and the polarizer 240 face each other with at least the liquid crystal layer 220 interposed therebetween. More specifically, the polarizer 230 and the polarizer 240 are positioned so as to sandwich the counter substrate 210, the liquid crystal layer 220, and the active matrix substrate 201. A pair of the polarizers 230 and 240 are disposed in a crossed-Nicol manner.

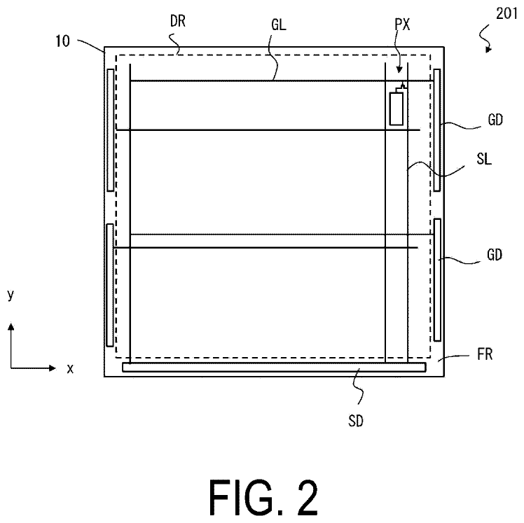

FIG. 2 is a schematic view illustrating an example of a planar structure of the active matrix substrate 201 of the liquid crystal display device according to the present embodiment. The active matrix substrate 201 includes a substrate 10 that includes, on a main surface thereof, a display region DR, and a non-display region FR that is a region other than the display region DR. The display region DR includes a plurality of pixels PX arrayed in a matrix shape in an x direction (second direction) and a y direction (first direction) orthogonal to the x direction. The non-display region FR is a region located in peripheral edges of the display region DR and does not contribute to display.

The active matrix substrate 201 includes a plurality of source bus lines SL and a plurality of gate bus lines GL in the display region DR. For example, the plurality of source bus lines SL extend in the y direction, and the plurality of gate bus lines GL extend in the x direction.

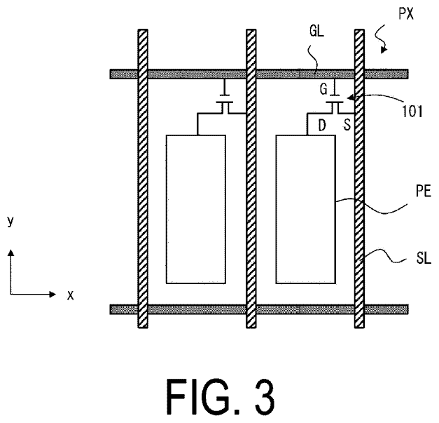

FIG. 3 is a schematic view illustrating a circuit configuration of the pixel PX of the active matrix substrate 201. Each of the pixels PX includes a pixel TFT 101 and a pixel electrode PE. As illustrated in FIG. 3, each of the pixels PX is connected to one of the plurality of gate bus lines GL and one of the plurality of source bus lines SL. More specifically, a gate G of the pixel TFT 101 is connected to the gate bus line GL, and a source S of the pixel TFT 101 is connected to the source bus line SL. Further, a drain D is electrically connected to the pixel electrode PE.

As illustrated in FIG. 2, the active matrix substrate 201 includes, in the non-display region FR of the substrate 10, a drive circuit including a gate driver GD and a source driver SD.

As described above, for example, when the active matrix substrate 201 is used in a display device for a head-mounted display, it is preferable that the TFT for driving the pixel include an oxide semiconductor layer excellent in low leakage performance. On the other hand, it is preferable that the drive circuit be constituted by a TFT having a large drive current. For example, the drive circuit preferably includes a plurality of TFTs each including a low-temperature polysilicon (polycrystalline silicon) semiconductor layer.

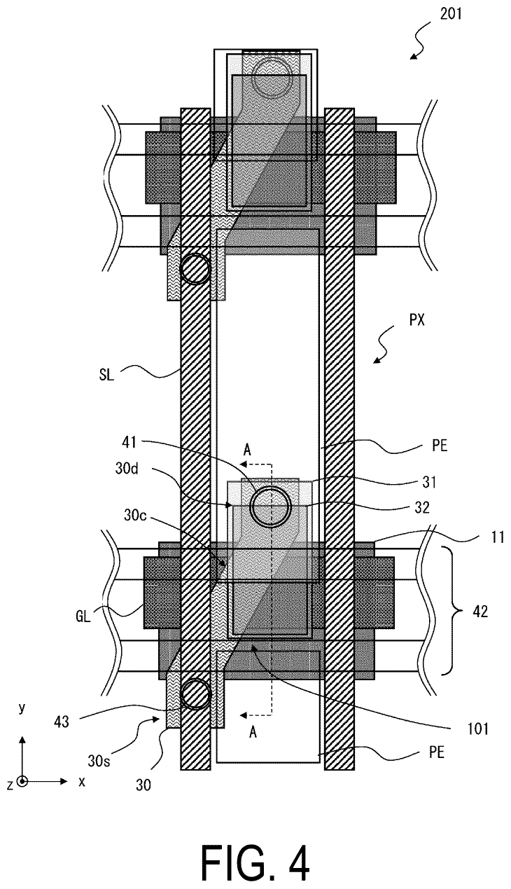

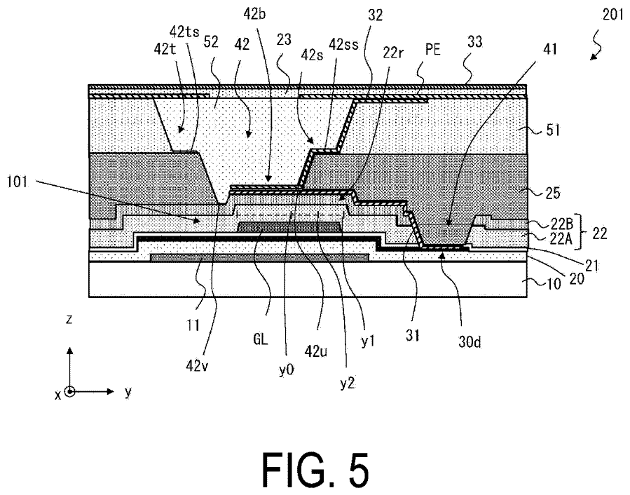

FIG. 4 is a plan view illustrating main constituent elements of the pixel PX of the active matrix substrate 201, and FIG. 5 illustrates a structure of the active matrix substrate 201 at a cross section taken along a line A-A in FIG. 4. In FIG. 4, in order to clearly illustrate how the constituent elements overlap one another, some of the constituent elements are illustrated so that the underlying structure thereof is visible. Further, in FIG. 4, a common electrode, a color filter layer, and various insulating layers, which will be described later, are not illustrated. The structure of each pixel in the active matrix substrate 201 will be described in detail with reference to FIGS. 4 and 5.

The pixel PX of the active matrix substrate 201 includes, in addition to the pixel TFT 101 and the pixel electrode PE described above, a light blocking layer 11, an underlayer 20, a first insulator 21, a second insulator 22, a color filter layer 25, a first flattening layer 51, a second flattening layer 52, a dielectric layer 23, a first pixel electrode 31, a second pixel electrode 32, and a common electrode 33. Further, the pixel TFT 101 includes a semiconductor layer 30 and a gate electrode that is a portion of the gate bus line GL.

The substrate 10 is, for example, a light-transmissive glass substrate. In the specification of the present application, the term “light-transmissive” means allowing at least light in a wavelength band of visible light to pass through. In the present embodiment, the pixel TFT 101 is a top-gate TFT, and thus the light blocking layer 11 is disposed on the substrate 10 to suppress a leakage current due to light incident on a channel region 30c of the semiconductor layer 30. The light blocking layer 11 is made of, for example, a metal material used for the gate bus line GL, and blocks light in the wavelength band of visible light. The underlayer 20 is disposed on the substrate 10 so as to cover the light blocking layer 11.

The semiconductor layer 30 is disposed on the underlayer 20 so as to intersect the gate bus line GL in a plan view. The semiconductor layer 30 includes a source region 30s, a drain region 30d, and the channel region 30c located between the source region 30s and the drain region 30d. The source region 30s and the drain region 30d extend in parallel to the y axis. The channel region 30c is located below the gate bus line GL and extends obliquely in the y direction. A portion of the source region 30s is located below the source bus line SL.

The semiconductor layer 30 is preferably a transparent semiconductor layer. For example, the semiconductor layer 30 may be an amorphous oxide semiconductor, or a crystalline oxide semiconductor having a crystalline portion. Examples of the crystalline oxide semiconductor include a polycrystalline oxide semiconductor, a microcrystalline oxide semiconductor, and a crystalline oxide semiconductor having a c-axis oriented substantially perpendicular to the layer surface.

The semiconductor layer 30 may be a single layer, or may have a layered structure including two or more layers. When the semiconductor layer 30 has a layered structure, the semiconductor layer 30 may include an amorphous oxide semiconductor layer and a crystalline oxide semiconductor layer. Alternatively, the oxide semiconductor layer may include a plurality of crystalline oxide semiconductor layers having different crystal structures. The oxide semiconductor layer may include a plurality of amorphous oxide semiconductor layers. When the oxide semiconductor layer has a dual-layer structure including an upper layer and a lower layer, an energy gap of the oxide semiconductor included in the upper layer is preferably greater than an energy gap of the oxide semiconductor included in the lower layer. However, when a difference in the energy gap between these layers is relatively small, the energy gap of the oxide semiconductor in the lower layer may be greater than the energy gap of the oxide semiconductor in the upper layer. The oxide semiconductor layer is described in detail in JP 2014-007399 A, for example, the disclosure of which is herein incorporated by reference.

The semiconductor layer 30 may include, for example, at least one metal element selected from In, Ga, and Zn. In the present embodiment, the semiconductor layer 30 includes, for example, an In—Ga—Zn—O-based semiconductor (for example, indium gallium zinc oxide). Here, the In—Ga—Zn—O-based semiconductor is a ternary oxide of In, Ga, and Zn, and a composition ratio of In, Ga, and Zn is not particularly limited. For example, the composition ratio may be In:Ga:Zn=2:2:1, In:Ga:Zn=1:1:1, In:Ga:Zn=1:1:2, or the like. The semiconductor layer 30 may be formed of an oxide semiconductor film including the In—Ga—Zn—O-based semiconductor.

The semiconductor layer 30 may include another oxide semiconductor in place of the In—Ga—Zn—O-based semiconductor. For example, the semiconductor layer 30 may include an In—Sn—Zn—O-based semiconductor (for example, In₂O₃—SnO₂—ZnO; InSnZnO). The In-Sn-Zn—O-based semiconductor is a ternary oxide of In (indium), Sn, and Zn. Alternatively, the semiconductor layer 30 may include an In—Al—Zn—O-based semiconductor, an In—Al—Sn—Zn—O-based semiconductor, a Zn—O-based semiconductor, an In-Zn—O-based semiconductor, a Zn—Ti—O-based semiconductor, a Cd—Ge—O-based semiconductor, a Cd—Pb—O-based semiconductor, a CdO (cadmium oxide), an Mg—Zn—O-based semiconductor, an In—Ga—Sn—O-based semiconductor, an In—Ga—O-based semiconductor, a Zr—In—Zn—O-based semiconductor, an Hf—In—Zn—O-based semiconductor, an Al—Ga—Zn—O-based semiconductor, or a Ga—Zn—O-based semiconductor.

The source region 30s and the drain region 30d are electronically conductive. For example, the source region 30s and the drain region 30d may be formed by reducing the resistance of the oxide semiconductor, by irradiating the semiconductor layer 30 with laser light, using the gate bus line GL as a mask. The method of reducing the resistance is not limited to the laser light irradiation, and the resistance may be reduced by subjecting the semiconductor layer 30 to an ion implantation process such as ion doping. Alternatively, the source region 30s and the drain region 30d may be formed by subjecting the semiconductor layer 30 to the argon plasma treatment. Alternatively, the source region 30s and the drain region 30d may be formed via reaction between the semiconductor layer 30 and an Al film formed on the semiconductor layer 30.

The first insulator 21 is disposed on the underlayer 20 so as to cover the semiconductor layer 30. A portion of the first insulator 21 is located between the semiconductor layer 30 and the gate bus line GL, and this portion functions as a gate insulating layer. The first insulator 21 is made of, for example, silicon oxide. The first insulator 21 may be provided at least between the gate bus line GL and the semiconductor layer 30, that is, only directly below the gate bus line GL.

The gate bus line GL is located on the first insulator 21. The gate bus line GL is made of a metal material such as aluminum, copper, titanium, molybdenum, chromium, or an alloy thereof. The gate bus line GL includes one or more layers made of any of these metal materials.

The second insulator 22 is located at least on the gate bus line GL. In the present embodiment, the second insulator 22 is disposed on the first insulator 21 so as to cover the gate bus line GL. The second insulator 22 includes a first inorganic insulating layer 22A and a second inorganic insulating layer 22B. The first inorganic insulating layer 22A and the second inorganic insulating layer 22B are made of, for example, silicon oxide or silicon nitride.

The source bus line SL is located on the first inorganic insulating layer 22A. The source bus line SL overlaps the semiconductor layer 30 in a plan view. The source bus line SL is connected to the source region 30s of the semiconductor layer 30, by a third contact hole 43 provided in the first inorganic insulating layer 22A and the first insulator 21. The source bus line SL is made of a metal material such as aluminum, copper, titanium, molybdenum, chromium, or an alloy thereof. The source bus line SL includes one or more layers made of any of these metal materials.

The second inorganic insulating layer 22B is located on the first inorganic insulating layer 22A so as to cover the source bus line SL. The upper surface of the second inorganic insulating layer 22B, that is, the upper surface of the second insulator 22, is raised at a position above the gate bus line GL, and a ridge 22r extending in the x-axis direction is formed.

A first contact hole 41 is formed to extend through the first insulator 21 and the second insulator 22 in the thickness direction. A portion of the drain region 30d of the semiconductor layer 30 is exposed at the bottom portion of the first contact hole 41. The first contact hole 41 has, for example, an inverted truncated cone shape such that a substantially circular opening is formed in the second insulator 22. The first contact hole 41 may be provided at least in the second insulator 22. Thus, when the first insulator 21 is located only between the gate bus line GL and the semiconductor layer 30, the first contact hole 41 only extends through the second insulator 22.

The first pixel electrode 31 is located at least on a portion of the second insulator 22 and in a portion of the first contact hole 41. In the first contact hole 41, an end of the first pixel electrode 31 is connected to the semiconductor layer 30. The other end is located on the ridge 22r of the second insulator 22 and overlaps with the gate bus line GL in a plan view. The first pixel electrode 31 is made of a transparent conductor such as ITO or IZO.

The color filter layer 25 is located on the second insulator 22 in each pixel PX so as to cover the first pixel electrode 31. The color filter layer 25 is, for example, a color filter colored in red, a color filter colored in blue, or a color filter colored in green, and each pixel PX includes one of these color filters. For example, in a row of the pixels PX in the y direction, each pixel includes a color filter of the same color, and in a row of the pixels PX in the x direction, each pixel includes one of the red, blue, and green color filters in order.

The first flattening layer 51 is disposed on the color filter layer 25. The first flattening layer 51 is a flattening film that flattens the uneven surface of the color filter layer 25, and the upper surface of the first flattening layer 51 is substantially flat. The first flattening layer 51 is made of, for example, an organic insulator such as a photosensitive acrylic resin.

The second contact hole 42 is provided in the color filter layer 25 and the first flattening layer 51. The second contact hole 42 extends through the first flattening layer 51 and the color filter layer 25, and a portion of the first pixel electrode 31 is exposed at a bottom portion 42b and at a position above the gate bus line GL.

As illustrated in FIG. 4, the second contact hole 42 extends in the x-axis direction and is continuous with the second contact hole 42 of a neighboring pixel PX. Thus, the second contact hole 42 has an integral groove shape. Each of the second contact holes 42 has a first sidewall portion 42s, a second sidewall portion 42t, and a bottom portion 42b which extend in the x-axis direction. The bottom portion 42b is located between the first sidewall portion 42s and the second sidewall portion 42t. A first boundary 42u is located between the first sidewall portion 42s and the bottom portion 42b, and a second boundary 42v is located between the second sidewall portion 42t and the bottom portion 42b. The first sidewall portion 42s and the first boundary 42u are closer to the first contact hole 41 than the second sidewall portion 42t and the second boundary 42v.

In the present embodiment, the first sidewall portion 42s and the second sidewall portion 42t include a step 42ss and a step 42ts, respectively, in a cross section perpendicular to the x-axis. The step 42ss and the step 42ts are formed by, for example, forming the second contact hole 42 in two steps.

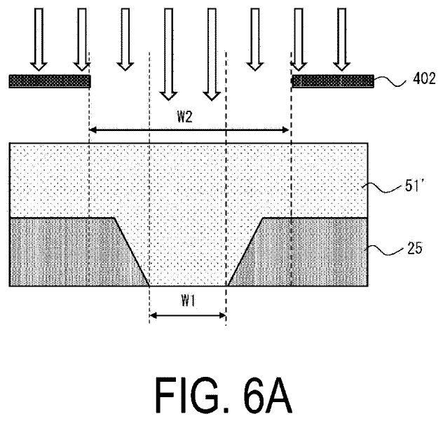

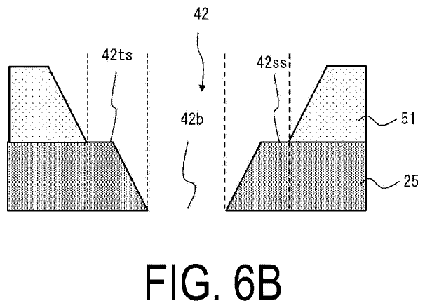

Specifically, as illustrated in FIG. 6A, after forming the color filter layer 25 having an opening W1 at the bottom portion, a first flattening film 51′ is formed on the color filter layer 25, and the first flattening film 51′ is developed by exposure to light through a photomask 402 having an opening W2 larger than the opening W1. As a result, the second contact hole 42 can be formed as illustrated in FIG. 6B. As necessary, a baking process may be performed after the color filter layer 25 and the first flattening layer 51 are formed, or an ashing process for removing a residue in the second contact hole 42 may be performed.

The opening W1 defines the size of the bottom portion 42b of the second contact hole 42. The opening W2 defines the size of the opening between a part of the first flattening layer 51 at the step 42ss and a part of the first flattening layer 51 at the step 42ts.

In the active matrix substrate 201, one of the first boundary 42u and the second boundary 42v is located on the gate bus line GL in a plan view, and the other is located outside the region above the gate bus line GL. As illustrated in FIG. 5, in the present embodiment, the first boundary 42u is located above the gate bus line GL in a plan view, and the second boundary 42v is located outside the region above the gate bus line GL.

When the position of the center of the gate bus line GL in the y-axis direction is defined as y0, the position of the edge of the gate bus line GL on the first contact hole 41 side is defined as y1, and the position of the middle point between y0 and y1 is defined as y2, as illustrated in FIG. 5, the first boundary 42u is designed to be located between y0 and y1 in a plan view, and in particular, preferably formed at or near y2. Designing the positional relationship between the first boundary 42u and the gate bus line GL in this manner makes it possible to avoid the situation where the first boundary 42u does not overlap the gate bus line in a plan view due to a significant positional offset toward the outside, even if the mask for forming the second contact hole 42 is misaligned in the y-axis direction. Therefore, as described below, the risk of disconnection of the second pixel electrode 32 formed in the second contact hole 42 is reduced.

The second pixel electrode 32 is located on the first flattening layer 51 and in the second contact hole 42. At the bottom portion of the second contact hole 42, the second pixel electrode 32 is connected to the first pixel electrode 31. The second pixel electrode 32 is made of a transparent conductor such as ITO or IZO.

The second flattening layer 52 covers the second pixel electrode 32 in the second contact hole 42, fills the internal space of the second contact hole 42, and has a flattened upper surface. The second flattening layer 52 is made of, for example, an organic insulator such as a photosensitive acrylic resin.

The pixel electrode PE overlaps a portion of the second pixel electrode 32, and is located on the first flattening layer 51 and the second flattening layer 52. The pixel electrode PE is made of a transparent conductor such as ITO or IZO.

In the present embodiment, the pixel electrode PE and the second pixel electrode 32 are formed as separate components. However, when the pixel electrode PE does not need to be provided on the second flattening layer 52, the second pixel electrode 32 and the pixel electrode PE may be integrally formed as a single member.

The dielectric layer 23 covers the pixel electrode PE, and is located on the first flattening layer 51 and the second flattening layer 52. The dielectric layer 23 has insulating properties and is made of, for example, an inorganic material such as silicon oxide and silicon nitride.

The common electrode 33 is located on the dielectric layer 23, and covers the entire display region DR of the active matrix substrate 201. The common electrode 33 is made of, for example, a transparent conductor such as ITO.

The liquid crystal display device 301 of the present embodiment can be manufactured using a method similar to that for a general liquid crystal display device.

Next, effects of the liquid crystal display device 301 of the present embodiment will be described. As described above, the head-mounted display in which the liquid crystal display device 301 of the present embodiment may be used has a very high resolution. Therefore, the liquid crystal display device includes small pixels, and thus misalignment of a photomask during manufacturing may significantly affect the display performance and the manufacturing yield of the liquid crystal display device.

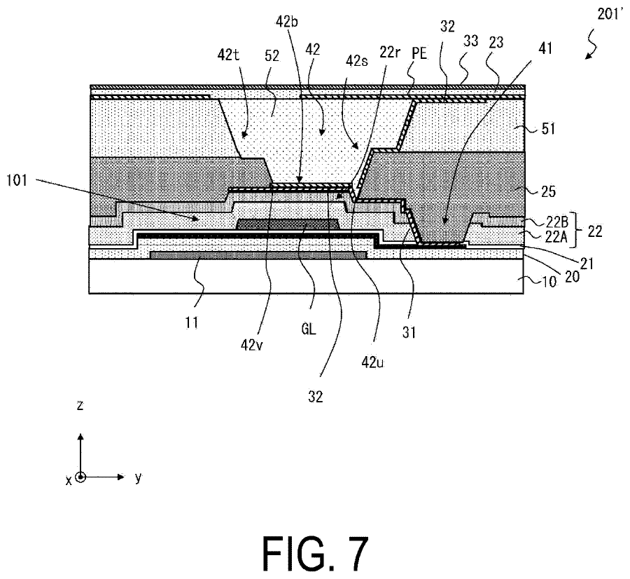

FIG. 7 illustrates a structure of an active matrix substrate 201′ of a liquid crystal display device according to a reference example, and in the structure, the first boundary 42u is located outside the gate bus line GL in a plan view, due to a positional offset of a mask for forming the second contact hole. In this case, the step of the ridge 22r of the second insulator 22 is located in the second contact hole 42. This results in discontinuity between the part of the second pixel electrode 32 in contact with the first sidewall portion 42s and the part of the second pixel electrode 32 in contact with the bottom portion 42b, resulting in formation of a crack. As a result, the second pixel electrode 32 and the first pixel electrode are not electrically connected to each other and are disconnected.

In contrast, according to the liquid crystal display device 301 of the present embodiment, the first boundary 42u of the second contact hole 42 overlaps with the gate bus line GL in a plan view. Therefore, even if there is a positional offset of a mask pattern for forming the second contact hole 42, occurrence of the situation where the first boundary 42u is formed to be located outside the region above the gate bus line GL can be suppressed. As a result, the second pixel electrode 32 is formed in the second contact hole 42 such that the part in contact with the first sidewall portion 42s and the part in contact with the bottom portion 42b are continuously formed, and thus disconnection due to a cracks is suppressed. Therefore, according to the present embodiment, even if the pixel size is small, the disconnection of the second pixel electrode is suppressed, and a high-resolution liquid crystal display device can be manufactured with a high yield.

In addition, the second sidewall portion 42t does not overlap with the gate bus line GL and is located outside the gate bus line GL in a plan view. As a result, even if there is a positional offset of a mask pattern for forming the second contact hole 42, the end portion of the first pixel electrode 31 is located in the bottom portion 42b of the second contact hole 42, and thus a sufficient contact area can be secured for the contact between the first pixel electrode 31 and the second pixel electrode 32 in the bottom portion 42b.

### Second Embodiment

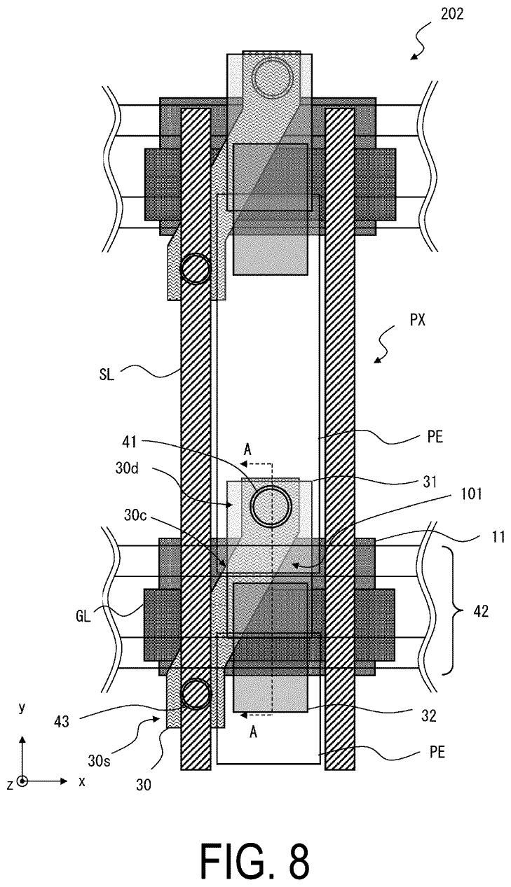

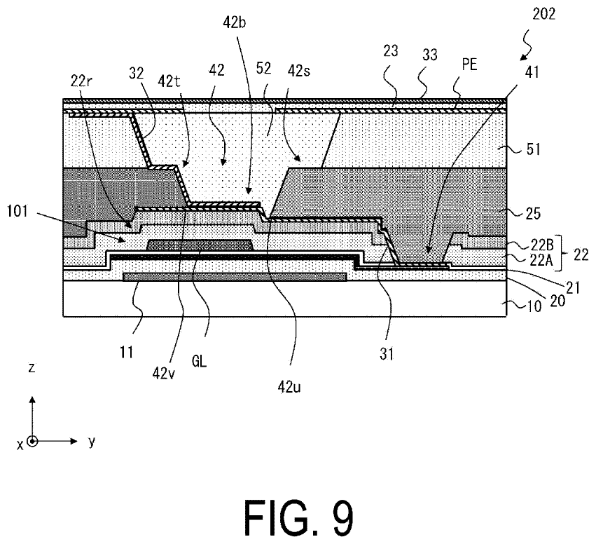

FIG. 8 is a plan view illustrating main constituent elements of the pixel PX of an active matrix substrate 202 of a liquid crystal display device of the present embodiment, and FIG. 9 is a cross-sectional view taken along a line A-A in FIG. 8 and illustrates the structure of the active matrix substrate 202. The active matrix substrate 202 is different from the active matrix substrate of the first embodiment in that the second boundary 42v overlaps the gate bus line GL and the first boundary 42u is located outside the gate bus line GL in a plan view.

In addition, the second pixel electrode 32 does not overlap the first contact hole 41 in a plan view, and extends to a neighboring pixel on the second sidewall portion 42t side in the y direction, and is connected to the pixel electrode PE of the neighboring pixel.

In the liquid crystal display device of the present embodiment, as in the liquid crystal display device of the first embodiment, even if there is positional offset of the second contact hole 42 due to misalignment during the manufacturing process, disconnection of the second pixel electrode 32 is suppressed. Therefore, a high-resolution liquid crystal display device can be manufactured with high yield.

### Third Embodiment

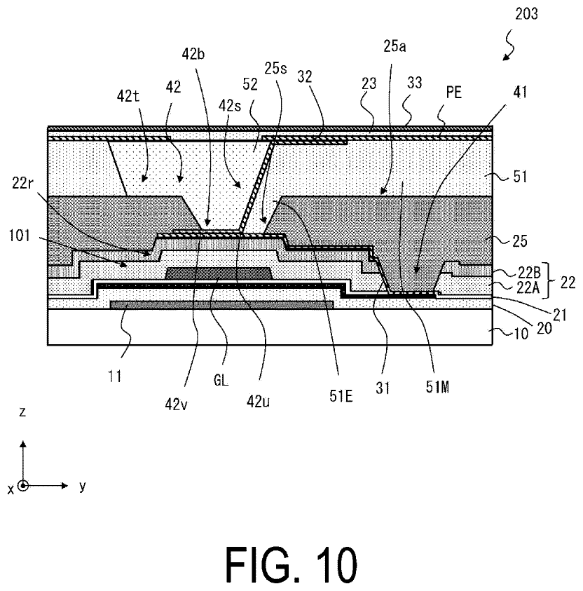

FIG. 10 is a schematic cross-sectional view of an active matrix substrate 203 of the liquid crystal display device of the present embodiment. The active matrix substrate 203 is different from the active matrix substrate of the first embodiment in that the first flattening layer 51 includes a main portion 51M and an extension portion 51E.

In the first flattening layer 51, the main portion 51M is located on an upper surface 25a of the color filter layer 25. At the first sidewall portion 42s on which the second pixel electrode 32 is located, the extension portion 51E covers at least a portion of a side portion 25s of the color filter layer 25. The second pixel electrode 32 is in contact with the first pixel electrode 31 and the extension portion 51E in the second contact hole 42. In the present embodiment, the extension portion 51E covers the entire side portion 25s of the color filter layer 25, and is continuous with the main portion 51M to form an integral shape.

On the other hand, on the second sidewall portion 42t, the first flattening layer 51 does not cover the side portion 25s of the color filter layer 25.

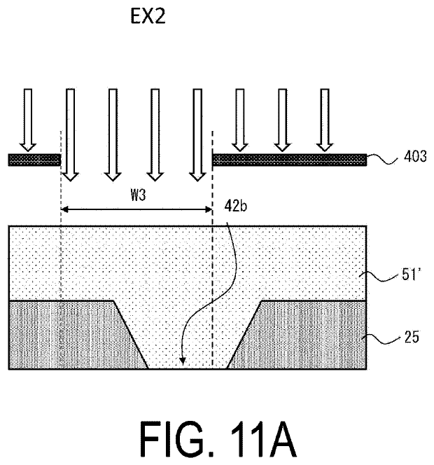

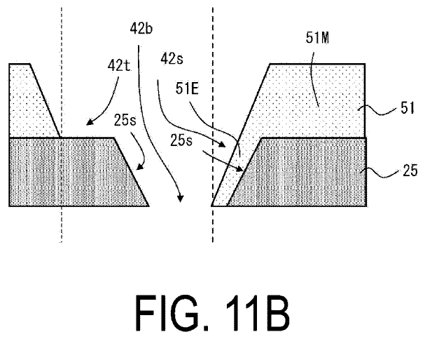

The active matrix substrate 203 can be formed by using a mask for forming the first flattening layer 51 which has an opening with a different size and position when forming the second contact hole 42. For example, as illustrated in FIG. 11A, after formation of the color filter layer 25, the first flattening film 51′ is formed on the color filter layer 25, and the first flattening film 51′ is exposed to light through a photomask 403 having an opening W3. During the exposure, one edge of the opening W3 is located in the bottom portion 42b of the second contact hole 42 in a plan view, and thus the internal space of the second contact hole 42 is formed such that in the first sidewall portion 42s, the first flattening layer 51 covers the side portion 25s of the color filter layer 25, as illustrated in FIG. 11B. On the other hand, in the second sidewall portion 42t, the first flattening film 51′ is removed and the side portion 25s of the color filter layer 25 is exposed.

According to the liquid crystal display device of the present embodiment, the extension portion 51E of the first flattening layer 51 is located in the first sidewall portion 42s on which the second pixel electrode 32 is located. Therefore, even if, due to a positional offset of the photomask for forming the second contact hole 42, a portion of the opening of the second contact hole 42 in the color filter layer 25 is located outside the gate bus line in a plan view so that a step is formed, the extension portion 51E of the first flattening layer 51 can fill the step. Therefore, disconnection of the second pixel electrode 32 can be suppressed, and thus a high-resolution liquid crystal display device can be manufactured with high yield.

In addition, in the present embodiment, contact between the second pixel electrode 32 and the color filter layer 25 can be suppressed. Thus, even if the material forming the color filter layer 25 is reactive with the transparent conductive film such as ITO or IZO forming the second pixel electrode 32 and the reaction may change the film quality or the crystallinity, formation of a portion with a changed film quality or a changed crystallinity in the second pixel electrode 32 can be suppressed.

In the second sidewall portion 42t, the side portion 25s of the color filter layer 25 is not covered with the first flattening layer 51. That is, the opening W3 can be set to be large, and thus the first flattening film 51′ can be sufficiently exposed, and formation of the extension portion 51E of the first flattening layer 51 having an unnecessarily increased thickness can be suppressed. Therefore, the influence of size reduction of the bottom portion 42b of the second contact hole 42 can be minimized, and the opening W1 of the color filter layer 25 does not need to be widened. As a result, it is possible to suppress a decrease in the aperture ratio of the pixel while securing a sufficient contact area between the first pixel electrode 31 and the second pixel electrode 32.

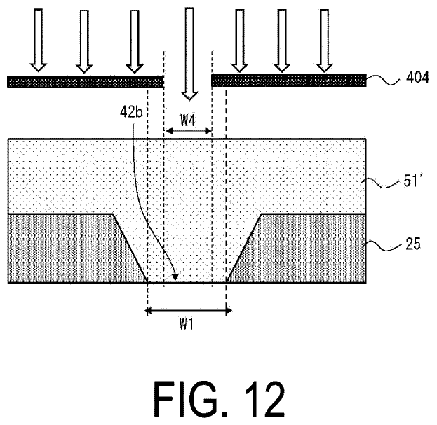

For example, if the extension portion 51E of the first flattening layer 51 is formed also on the second sidewall portion 42t, an opening W4 of a photomask 404 for forming the first flattening layer 51 needs to be smaller than the opening W1 of the color filter layer 25, as illustrated in FIG. 12. As a result, the opening W4 may be too small to sufficiently expose the first flattening film 51′ to light, and thus the extension portion 51E of the first flattening layer 51 may be formed to be thicker than necessary. This leads to formation of the bottom portion 42b of the second contact hole 42 that is too small to meet design requirements. If the opening W4 having a larger size is formed to secure a sufficient size of the bottom portion 42b of the second contact hole 42, the opening W1 of the color filter layer 25 needs to be further increased, and thus the pixel aperture ratio of the pixel is decreased.

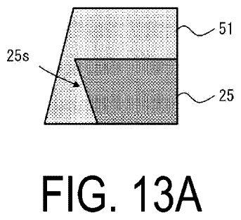

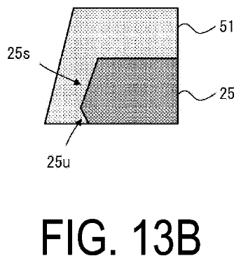

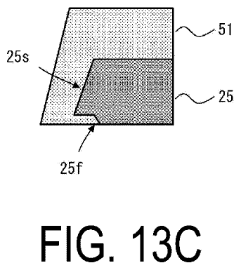

In the cross-sectional view illustrated in FIG. 10, the side portion 25s of the color filter layer 25 has a forwardly tapered shape. However, the color filter layer 25 needs to satisfy certain optical characteristics such as a transmission wavelength band and transmittance, and thus the composition of the material for forming the color filter layer 25 may vary depending on the optical characteristics. Thus, there may be a case where process conditions of the forming process of the color filter layer 25 including a photolithography process, may not be determined such that the side portion 25s having a forwardly tapered shape is formed. As a result, the side portion 25s of the color filter layer 25 may have an inversely tapered shape, as illustrated in FIG. 13A, a forwardly tapered shape with an undercut 25u, as illustrated in FIG. 13B, or a side shift 25f on the second insulator 22 side, as illustrated in FIG. 13C.

Even in these cases, disconnection of the second pixel electrode 32 can be suppressed by forming the extension portion 51E of the first flattening layer 51 so as to cover the side portion 25s, as illustrated in FIG. 13A to FIG. 13C.

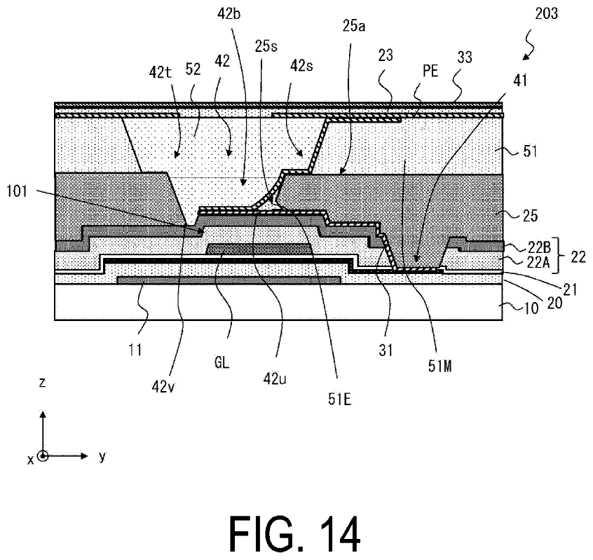

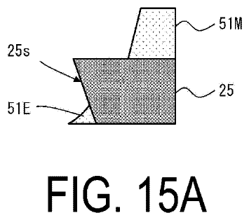

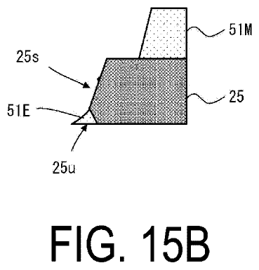

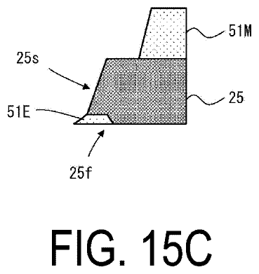

As understood from the above description, disconnection of the second pixel electrode 32 due to the positional offset of the second contact hole 42 occurs at or near the first boundary 42u or the second boundary 42v where the second pixel electrode 32 is located. Therefore, the extension portion 51E of the first flattening layer 51 may be formed to cover the first boundary 42u or the second boundary 42v. For example, as illustrated in FIG. 14, the extension portion 51E may be disposed at a position in the first sidewall portion 42s such that the extension portion 51E is in contact with a portion of the first pixel electrode 31 and a portion of the side portion 25s of the color filter layer 25. In this case, it is preferable that the extension portion 51E has a tip with an acute angle taper. For example, as illustrated in FIG. 15A to FIG. 15C, the extension portion 51E may be formed to cover the bottom portion of the inversely tapered shape illustrated in FIG. 15A, or to cover the undercut 25u illustrated in FIG. 15B and the side shift 25f illustrated in FIG. 15C.

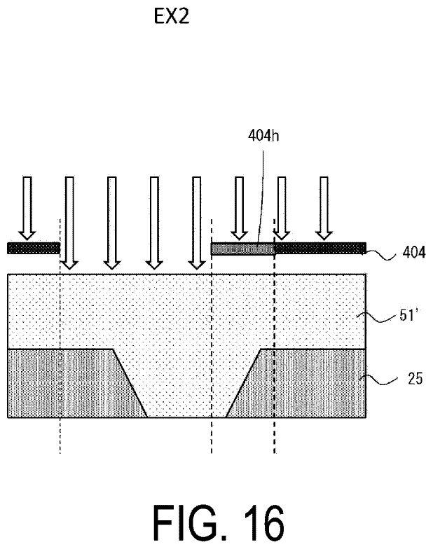

These extension portions 51E are separated from the main portion 51M of the first flattening layer 51. Such an extension portion 51E can be formed by, for example, when the first flattening layer 51 is formed, exposing the first flattening film 51′ to light through a photomask 404 having a halftone part 404h located above a region where the extension portion 51E is to be formed, as illustrated in FIG. 16.

A liquid crystal display device according to the disclosure can be described as follows.

A liquid crystal display device according to a first configuration includes an active matrix substrate, a counter substrate disposed opposite the active matrix substrate, and a liquid crystal layer located between the active matrix substrate and the counter substrate,
the active matrix substrate includes,
a substrate including a display region,
a plurality of source bus lines extending in a first direction in the display region,
a plurality of gate bus lines extending in a second direction intersecting the first direction in the display region, and
a plurality of pixels located on the display region of the substrate, each of the plurality of pixels being connected to one of the plurality of source bus lines and one of the plurality of gate bus lines,
each of the plurality of pixels includes,
a semiconductor layer located between the substrate and the one gate bus line and partially overlapping with the one gate bus line in a plan view,
a first insulator located at least between the semiconductor layer and the one gate bus line and covering the semiconductor layer,
a second insulator located at least on the one gate bus line and on the first insulator,
a first contact hole extending at least through the second insulator to expose a portion of the semiconductor layer,
a first pixel electrode located at least on a portion of the second insulator and in a portion of the first contact hole and connected to the semiconductor layer, the first pixel electrode partially overlapping with the one gate bus line in a plan view,
a color filter layer disposed in the pixel to cover the first pixel electrode,
a second contact hole extending through the color filter layer to expose the first pixel electrode at a position above the one gate bus line, and
a second pixel electrode located above the color filter layer and at least in a portion of the second contact hole, and connected to the first pixel electrode,
the second contact hole has a groove shape extending in parallel to the second direction and being continuous with the second contact hole of a neighboring pixel,
the second contact hole includes a first sidewall portion and a second sidewall portion each extending in parallel to the second direction, and further includes a bottom portion located between the first sidewall portion and the second sidewall portion, a first boundary between the bottom portion and the first sidewall portion, and a second boundary between the bottom portion and the second sidewall portion, and
the first boundary is closer to the first contact hole than the second boundary, and at least one of the first boundary or the second boundary is located above the one gate bus line in a plan view.

According to the first configuration, the first boundary of the second contact hole overlaps with the gate bus line in a plan view. Thus, even if there is a positional offset of a photomask for forming the second contact hole, occurrence of the situation where the first boundary is formed to be located outside the region above the gate bus line can be suppressed. Therefore, disconnection of the second pixel electrode is suppressed, and a high-resolution liquid crystal display device can be manufactured with a high yield.

A liquid crystal display device according to a second configuration is the liquid crystal display device according to the first configuration in which the first boundary may be located above the one gate bus line in a plan view, and the second pixel electrode may cover the first boundary.

A liquid crystal display device according to a third configuration is the liquid crystal display device according to the second configuration in which the second pixel electrode may overlap with the first contact hole in a plan view.

A liquid crystal display device according to a fourth configuration is the liquid crystal display device according to the first configuration in which the second boundary may be located above the one gate bus line in a plan view, and the second pixel electrode may cover the second boundary.

A liquid crystal display device according to a fifth configuration is the liquid crystal display device according to the second configuration in which the second pixel electrode may not overlap with the first contact hole in a plan view.

A liquid crystal display device according to a sixth configuration is the liquid crystal display device according to any one of the first to fifth configurations in which the second pixel electrode may be in contact with the color filter layer in the second contact hole.

A liquid crystal display device according to a seventh configuration is the liquid crystal display device according to any one of the first to fifth configurations which may further include a first flattening layer located on the color filter layer, and in which the second contact hole may further extend through the first flattening layer.

A liquid crystal display device according to an eighth configuration is the liquid crystal display device according to any one of the first to fifth configurations in which the other of the first boundary and the second boundary may be located outside the one gate bus line in a plan view.

A liquid crystal display device according to a ninth configuration includes an active matrix substrate, a counter substrate disposed opposite the active matrix substrate, and a liquid crystal layer located between the active matrix substrate and the counter substrate,
the active matrix substrate includes,
a substrate including a display region,
a plurality of source bus lines extending in a first direction in the display region,
a plurality of gate bus lines extending in a second direction intersecting the first direction in the display region, and
a plurality of pixels located on the display region of the substrate, each of the plurality of pixels being connected to one of the plurality of source bus lines and one of the plurality of gate bus lines,
each of the plurality of pixels includes,
a semiconductor layer located between the substrate and the one gate bus line and partially overlapping with the one gate bus line in a plan view,
a first insulator located at least between the semiconductor layer and the one gate bus line,
a second insulator located at least on the one gate bus line,
a first contact hole extending at least through the second insulator to expose a portion of the semiconductor layer,
a first pixel electrode located at least on a portion of the second insulator and in a portion of the first contact hole and connected to the semiconductor layer, the first pixel electrode partially overlapping with the one gate bus line in a plan view,
a color filter layer disposed in the pixel to cover the first pixel electrode,
a first flattening layer disposed on the color filter,
a second contact hole extending through the first flattening layer and the color filter layer to expose the first pixel electrode at a position above the one gate bus line, and
a second pixel electrode located above the color filter layer and at least in a portion of the second contact hole, and connected to the first pixel electrode,
the second contact hole has a groove shape extending in parallel to the second direction and being continuous with the second contact hole of a neighboring pixel,
the second contact hole includes a first sidewall portion and a second sidewall portion each extending in parallel to the second direction, and further includes a bottom portion located between the first sidewall portion and the second sidewall portion, a first boundary between the bottom portion and the first sidewall portion, and a second boundary between the bottom portion and the second sidewall portion,
the first boundary is closer to the first contact hole than the second boundary,
one of the first boundary and the second boundary is located above the one gate bus line in a plan view,
the first flattening layer includes a main portion located on an upper surface of the color filter layer, and an extension portion covering at least a portion of a side portion of the color filter layer, in the sidewall portion where the one of the first boundary and the second boundary is located, and
the second pixel electrode is in contact with the first pixel electrode and the extension portion in the second contact hole.

According to the ninth configuration, the extension portion of the first flattening layer is located in the first sidewall portion on which the second pixel electrode is located. Therefore, even if, due to a positional offset of the photomask for forming the second contact hole, a portion of the opening of the second contact hole in the color filter layer is located outside the gate bus line in a plan view so that a step is formed, the extension portion of the first flattening layer can fill the step. Therefore, disconnection of the second pixel electrode can be suppressed, and thus a high-resolution liquid crystal display device can be manufactured with a high yield.

A liquid crystal display device according to a tenth configuration is the liquid crystal display device according to the ninth configuration in which the extension portion may cover the entirety of the side portion of the color filter layer, and the main portion and the extension portion may be continuous.

A liquid crystal display device according to an eleventh configuration is the liquid crystal display device according to the ninth configuration in which the extension portion may cover only a part of the side portion of the color filter layer, and the main portion and the extension portion may be separated from each other.

A liquid crystal display device according to a twelfth configuration is the liquid crystal display device according to the ninth or tenth configuration in which the color filter layer may include a forward taper, an inverse taper, an undercut, or a side shift, in a sidewall portion where the one of the first boundary and the second boundary is located.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A liquid crystal display device comprising:
an active matrix substrate;
a counter substrate disposed opposite the active matrix substrate; and
a liquid crystal layer located between the active matrix substrate and the counter substrate,
wherein the active matrix substrate includes,
a substrate including a display region,
a plurality of source bus lines extending in a first direction in the display region,
a plurality of gate bus lines extending in a second direction intersecting the first direction in the display region, and
a plurality of pixels located on the display region of the substrate, each of the plurality of pixels being connected to one of the plurality of source bus lines and one of the plurality of gate bus lines,
each of the plurality of pixels includes,
a semiconductor layer located between the substrate and the one gate bus line and partially overlapping with the one gate bus line in a plan view,
a first insulator located at least between the semiconductor layer and the one gate bus line,
a second insulator located at least on the one gate bus line,
a first contact hole extending at least through the second insulator to expose a portion of the semiconductor layer,
a first pixel electrode located at least on a portion of the second insulator and in a portion of the first contact hole and connected to the semiconductor layer, the first pixel electrode partially overlapping with the one gate bus line in a plan view,
a color filter layer disposed in the pixel to cover the first pixel electrode,
a second contact hole extending through the color filter layer to expose the first pixel electrode at a position above the one gate bus line, and
a second pixel electrode located above the color filter layer and at least in a portion of the second contact hole, and connected to the first pixel electrode,
the second contact hole has a groove shape extending in parallel to the second direction and being continuous with the second contact hole of a neighboring pixel,
the second contact hole includes a first sidewall portion and a second sidewall portion each extending in parallel to the second direction, and further includes a bottom portion located between the first sidewall portion and the second sidewall portion, a first boundary between the bottom portion and the first sidewall portion, and a second boundary between the bottom portion and the second sidewall portion, and
the first boundary is closer to the first contact hole than the second boundary, and at least one of the first boundary or the second boundary is located above the one gate bus line in a plan view.

2. The liquid crystal display device according to claim 1,
wherein the first boundary is located above the one gate bus line in a plan view, and
the second pixel electrode covers the first boundary.

3. The liquid crystal display device according to claim 2,
wherein the second pixel electrode overlaps with the first contact hole in a plan view.

4. The liquid crystal display device according to claim 1,
wherein the second boundary is located above the one gate bus line in a plan view, and
the second pixel electrode covers the second boundary.

5. The liquid crystal display device according to claim 2,
wherein the second pixel electrode does not overlap with the first contact hole in a plan view.

6. The liquid crystal display device according to claim 1,
wherein the second pixel electrode is in contact with the color filter layer in the second contact hole.

7. The liquid crystal display device according to claim 1, further comprising:
a first flattening layer located on the color filter layer,
wherein the second contact hole further extends through the first flattening layer.

8. The liquid crystal display device according to claim 1,
wherein the other of the first boundary and the second boundary is located outside the one gate bus line in a plan view.

9. A liquid crystal display device comprising:
an active matrix substrate;
a counter substrate disposed opposite the active matrix substrate; and
a liquid crystal layer located between the active matrix substrate and the counter substrate,
wherein the active matrix substrate includes,
a substrate including a display region,
a plurality of source bus lines extending in a first direction in the display region,
a plurality of gate bus lines extending in a second direction intersecting the first direction in the display region, and
a plurality of pixels located on the display region of the substrate, each of the plurality of pixels being connected to one of the plurality of source bus lines and one of the plurality of gate bus lines,
each of the plurality of pixels includes,
a semiconductor layer located between the substrate and the one gate bus line and partially overlapping with the one gate bus line in a plan view,
a first insulator located at least between the semiconductor layer and the one gate bus line,
a second insulator located at least on the one gate bus line,
a first contact hole extending at least through the second insulator to expose a portion of the semiconductor layer,
a first pixel electrode located at least on a portion of the second insulator and in a portion of the first contact hole and connected to the semiconductor layer, the first pixel electrode partially overlapping with the one gate bus line in a plan view,
a color filter layer disposed in the pixel to cover the first pixel electrode,
a first flattening layer disposed on the color filter,
a second contact hole extending through the first flattening layer and the color filter layer to expose the first pixel electrode at a position above the one gate bus line, and
a second pixel electrode located above the color filter layer and at least in a portion of the second contact hole, and connected to the first pixel electrode,
the second contact hole has a groove shape extending in parallel to the second direction and being continuous with the second contact hole of a neighboring pixel,
the second contact hole includes a first sidewall portion and a second sidewall portion each extending in parallel to the second direction, and further includes a bottom portion located between the first sidewall portion and the second sidewall portion, a first boundary between the bottom portion and the first sidewall portion, and a second boundary between the bottom portion and the second sidewall portion,
the first boundary is closer to the first contact hole than the second boundary,
at least one of the first boundary or the second boundary is located above the one gate bus line in a plan view,
the first flattening layer includes a main portion located on an upper surface of the color filter layer, and an extension portion covering at least a portion of a side portion of the color filter layer, in the sidewall portion where the one of the first boundary and the second boundary is located, and
the second pixel electrode is in contact with the first pixel electrode and the extension portion in the second contact hole.

10. The liquid crystal display device according to claim 9,
wherein the extension portion covers the entirety of the side portion of the color filter layer, and the main portion and the extension portion are continuous.

11. The liquid crystal display device according to claim 9,
wherein the extension portion covers only a part of the side portion of the color filter layer, and the main portion and the extension portion are separated from each other.

12. The liquid crystal display device according to claim 9,
wherein the color filter layer includes a forward taper, an inverse taper, an undercut, or a side shift, in a sidewall portion where the one of the first boundary and the second boundary is located.
